(19) United States
(12) Patent Application Publication
(10) Pub. No.: US 2022/0278333 A1
(43) Pub. Date: Sep. 1, 2022

(54) CARBON AEROGEL-BASED LITHIUM METAL ANODE MATERIALS AND METHODS OF MANUFACTURE THEREOF

(71) Applicant: Aspen Aerogels, Inc., Northborough, MA (US)

(72) Inventors: Nicholas A. Zafiropoulos, Wayland, MA (US); George L. Gould, Mendon, MA (US); Alexei Erchak, Easton, MA (US)

(73) Assignee: Aspen Aerogels, Inc., Northborough, MA (US)

(21) Appl. No.: 17/546,659

(22) Filed: Dec. 9, 2021

Related U.S. Application Data
(60) Provisional application No. 63/124,305, filed on Dec. 11, 2020.

(51) Int. Cl. H01M 4/80; H01M 4/38; H01M 4/66; H01M 4/36

(52) U.S. Cl. CPC H01M 4/808; H01M 4/382; H01M 4/663; H01M 4/366; H01M 2004/021

(57) ABSTRACT

The present disclosure discusses a system with a nanoporous carbon material with a pore structure and lithium metal disposed adjacent to the nanoporous carbon material. The present disclosure discussion includes an electrical energy storage device including at least one anode, at least one cathode, and an electrolyte comprising lithium ions, wherein the electrical energy storage device has a first cycle efficiency of at least 50% and a reversible capacity of at least 150 mAh/g.

### CROSS-REFERENCE TO RELATED APPLICATIONS

This application claims priority to U.S. Provisional Patent Application No. 63/124,305, filed Dec. 11, 2020, and which is herein incorporated by reference in its entirety.

### FIELD OF THE TECHNOLOGY

This present disclosure relates to nanoporous carbon-based materials. More specifically, this technology relates to carbon aerogels suitable for use in environments containing electrochemical reactions, for example as an electrode material within a lithium-ion battery.

### BACKGROUND

Aerogels are solid materials that include a highly porous network of micro-sized and meso-sized pores. Depending on precursor materials used and processing undertaken, the pores of an aerogel can account for over 90% of the volume when the density of the aerogel is about 0.05 g/cc. Aerogels can be prepared by removing the solvent from a gel (a solid network that contains its solvent) in a manner that minimal or no contraction of the gel can be brought by capillary forces at its surface. Methods of solvent removal include, but are not limited to, supercritical drying (or drying using supercritical fluids, such that the low surface tension of the supercritical fluid exchanges with the transient solvent within the gel), exchange of solvent with supercritical fluid, exchange of solvent with fluid that subsequently transformed to supercritical state, sub- or near-critical drying, and sublimating a frozen solvent in a freeze-drying process.

When drying in ambient conditions, gel contraction may take place with solvent evaporation, and a xerogel can form. Therefore, aerogel preparation through a sol-gel process or other polymerization processes can proceed in the following series of steps: dissolution of the solute in a solvent, formation of the sol/solution/mixture, formation of the gel (may involve additional cross-linking), and solvent removal by either supercritical drying technique or any other method that removes solvent from the gel with controlled pore collapse.

Aerogels can be formed of inorganic materials and/or organic materials. When formed of organic materials—such as phenols, resorcinol-formaldehyde (RF), phloroglucinol furfuraldehyde (PF), polyacrylonitrile (PAN), polyimide (PI), polyurethane (PU), polybutadiene, polydicyclopentadiene, and precursors or polymeric derivatives thereof, for example—the aerogel may be carbonized (e.g., by pyrolysis) to form a carbon aerogel.

### SUMMARY

Carbon aerogels can have properties (e.g., pore volume, pore size distribution, morphology, etc.) that differ or overlap from each other, depending on the precursor materials and methodologies used. In all cases for carbon aerogels, there have been certain deficiencies based on material and application, for example low pore volume, wide pore size distribution, low mechanical strength, etc. The present disclosure uses carbon aerogels as electrode materials with an increase in performance for applications in energy storage devices, such as lithium-metal anodes for high-energy batteries.

Lithium metal anodes can be used to increase the energy density of lithium batteries. As an anode material, lithium metal is an attractive choice based on the lithium's high theoretical specific capacity (3,860 mAh/g), low atomic weight, and lowest electrochemical potential. Lithium metal anodes are a candidate for next-generation lithium batteries that go beyond lithium-ion, including solid-state. Current state-of the-art commercial Li-ion battery technologies are capable of providing specific energy of about 250 Wh/kg. With Li-ion battery developments, such as anode developments, the specific energy of Li-ion batteries can be increased. Without wishing to be bound by theory, by reliably replacing existing anodes with lithium metal in Li-ion batteries, the specific energy can be nearly doubled. Extending even further, when combined with advanced cathodes, including Li-sulfur and Li-air, specific energies as high 1000 Wh/kg are possible. However, in order to become a viable technology, several challenges need to be addressed with lithium metal anodes, particular in regards to cycle life and safety.

These challenges include dendritic lithium deposition and dead lithium, which eventually lead to low cyclability and low Coulombic efficiency. Additional challenges include large dimensional changes during cycling as well as high manufacturing costs and low yields of thin lithium foil. These challenges contribute to poor cycle life and greater risk of cell shorting.

Lithium dendrite growth occurs at the interfacial space between the lithium metal and the separator. Persistent lithium dendrite growth will eventually pierce through the separator. Once contact is made with the cathode, an internal short circuit may occur, which can potentially lead to a thermal runaway event and explosion hazard. The lithium metal is also reactive to organic electrolytes and lithium salts to form an unstable solid electrolyte interphase (SEI) layer. The lack of stability in combination with repeated volumetric expansion and contraction during charging and discharge, leads to continuous and rapid consumption of additional electrolyte and lithium salts and ultimately poor Coulombic efficiency and short cycle life.

A leading theory for the formation of dendrites during charging (or often referred to as “plating”) is that the heterogeneous Li-ion conductivity, which exists along the SEI, leads to random nucleation of new lithium during plating. Once a nucleation event or multiple events occur at this interface, the lithium nucleation self-enhances and creates a locally concentrated higher electric field. The lithium nucleation goes on to attract more lithium-ions and eventually builds up dendrites capable of piercing through the separator. One of the leading contributions to lost Coulombic efficiency is a result of small lithium deposits breaking off from the anode during discharging and becoming isolated in the SEI layer. The isolated lithium is essentially “dead” and can no longer be cycled through the battery.

In order to address the random nucleation of new lithium during plating, the present disclosure uses carbon aerogel (such as polyimide-derived carbon aerogel), e.g., as a host for lithium. The carbon aerogel provides a 3D architecture of interconnected carbon nanorods that provides a network of interconnected pores within the framework of the 3D architecture, the size distribution of which is narrow and tunable. This 3D architecture helps promote formation of a uniform plating of lithium on the carbon aerogel surface. The porosity is tunable to provide pores of a size such that dendrites cannot form and lithium deposits cannot break off from the anode during discharge and get isolated by the SEI. The carbon aerogel can also act as a controlled lithium diffusion interface that suppresses the growth of lithium dendrites by regulating the Li+ ion flux and electric field during charge/discharge cycling.

The present disclosure may address one or more of the problems and deficiencies identified herein. However, it is contemplated that the present disclosure may prove useful in addressing other problems and deficiencies in a number of technical areas. Therefore, the claimed subject matter should not necessarily be construed as limited to addressing any of the particular problems or deficiencies discussed herein.

In one aspect, a system includes a nanoporous carbon material with a pore structure; and lithium metal disposed adjacent to the nanoporous carbon material. In some embodiments, the lithium metal disposed adjacent to the nanoporous carbon material comprises a layer of nanoporous carbon material electrically connected to the lithium metal and positioned between the lithium metal and a separator. In some embodiments, the layer of nanoporous carbon material is coated on the lithium metal and positioned between the lithium metal and a separator. In some embodiments, the nanoporous carbon material is in a particulate form. In some embodiments, the layer of nanoporous carbon material is a monolith bonded to the lithium metal and positioned between the lithium metal and a separator. In another aspect, a system includes a nanoporous carbon material comprising: a pore structure comprising a fibrillar morphology and an array of pores, wherein the array of pores is surrounding lithium metal. In some embodiments, the lithium metal is plated on nanoporous carbon material. In some embodiments, the lithium metal is melt infused into the pore structure of the nanoporous carbon material. In some embodiments, the nanoporous carbon material is in a particulate form. In some embodiments, the nanoporous carbon material is a monolith. In some embodiments, the nanoporous carbon material can include dopants, such as electrochemically active species. In some embodiments, the dopants are added to provide additional material properties to the aerogel, such as fire suppression or volumetric expansion. In some embodiments, the dopants are selected from the group consisting of dissolving materials in lithium (e.g., gold, silver, zinc, magnesium, platinum, and aluminum), non-dissolving materials in lithium (e.g., silicon and tin), and non-alloying materials with lithium (e.g., copper and nickel). In some embodiments, the nanoporous carbon can include additional dopants to further enhance the electrical conductivity, including graphene, graphene oxide, graphite, single-wall carbon nanotubes, multi-wall carbon nanotubes. In some embodiments, the nanoporous carbon material includes one or more of the dopants described herein. In some embodiments, the nanoporous carbon material comprises a carbon aerogel. In some embodiments, the carbon aerogel comprises a polyimide-derived carbon aerogel. In some embodiments, the pores form interconnected structures around the lithium metal, and the lithium metal and pore walls of each pore in which the lithium metal is surrounded are connected by a plurality of connection points.

In some embodiments, the nanoporous carbon material has a pore volume of at least 0.3 cc/g. In some embodiments, the nanoporous carbon material has a porosity between about 10% and about 90%. In some embodiments, the nanoporous carbon material has a capacity of between about 500 mAh/g and about 3000 mAh/g, between about 500 mAh/g and about 2500 mAh/g, about 500 mAh/g and about 2000 mAh/g. In some embodiments, the nanoporous carbon material has an electrical conductivity of at least about 1 S/cm. In some embodiments, the pore structure comprises a pore size distribution full width at half max of about 50 nm or less. In some embodiments, the pore structure comprises a pore size at max peak from distribution of about 100 nm or less. In some embodiments, an average strut width of the fibrillar morphology of the nanoporous carbon material ranges from about 2 nm to about 30 nm, about 2 nm to about 20 nm, about 2 nm to about 10 nm. In some embodiments, the nanoporous carbon material can be a monolith. In some embodiments, the nanoporous carbon material can be a powder. In some embodiments, the system is an energy storage system. In some embodiments, the energy storage system is a battery.

In another aspect, a method of controlling current at an interface in an energy storage system includes disposing lithium metal adjacent to a nanoporous carbon material. In some embodiments, the nanoporous carbon material is a carbon aerogel. In some embodiments, disposing lithium metal adjacent to a nanoporous carbon material comprises filling at least a portion of a void space in the nanoporous carbon material with the lithium metal. In some embodiments, disposing lithium metal adjacent to a nanoporous carbon material comprises electrically connecting a layer of nanoporous carbon material to the lithium metal. In some embodiments, electrically connecting a layer of nanoporous carbon material to the lithium metal comprises coating the nanoporous carbon material on the lithium metal. In some embodiments, the nanoporous carbon material is in a particulate form. In some embodiments, the layer of nanoporous carbon material is a monolith bonded to the lithium metal. In some embodiments, disposing lithium metal adjacent to a nanoporous carbon material comprises infiltrating a fluid into the void space of the nanoporous carbon material.

In another aspect, electrical energy storage device includes a) at least one anode comprising the system of claim 1 or claim 6; b) at least one cathode; and c) an electrolyte comprising lithium ions, wherein the electrical energy storage device has a first cycle efficiency of at least 50% and a reversible capacity of at least 150 mAh/g. In some embodiment, the anode is used in a solid-state system. In some embodiments, the at least one cathode is a conversion cathode, such as sulfur for lithium-sulfur batteries and oxygen/air for lithium air batteries, and/or an intercalation cathode, such as phosphates and transition metal oxides.

### BRIEF DESCRIPTION OF THE DRAWINGS

The technology will be more fully understood from the following detailed description taken in conjunction with the accompanying drawings, in which:

FIG. 1 is a flow diagram illustrating formation of a carbon aerogel for use within an energy storage application.

FIG. 2 displays an example of dendritic growth at the surface of lithium metal.

FIG. 3 displays a schematic illustration of a design of a Li-scaffold composite, in accordance with one aspect of the disclosure.

FIG. 4A, FIG. 4B and FIG. 4C display a lithium wetting property of various porous materials (e.g. carbon framework, metal foam) without the Si coating.

FIG. 5A, FIG. 5B and FIG. 5C display a lithium wetting property of various porous materials (e.g. Si-coated carbon framework, Si-coated metal foam) with the Si coating.

FIG. 6A, FIG. 6B, FIG. 6C and FIG. 6D display time-lapse images of a lithium melt-infusion process for lithiophobic materials. Images were taken after 0 seconds (FIG. 6A), 3 seconds (FIG. 6B), 6 seconds (FIG. 6C) and 9 seconds (FIG. 6D) contact with molten Li.

FIG. 7A, FIG. 7B, FIG. 7C and FIG. 7D display time-lapse images of a lithium melt-infusion process for lithiophilic materials. Images were taken after 0 seconds (FIG. 7A), 3 seconds (FIG. 7B), 6 seconds (FIG. 7C) and 9 seconds (FIG. 7D) contact with molten Li.

### DETAILED DESCRIPTION

The growing demand for high-energy density energy storage systems is reviving the attempts to use Li metal as the anode in the next generation of lithium batteries. Li foil produced at relevant thicknesses for the battery industry is currently cost prohibitive due to low yields and poor mechanicals. Sourcing and using Li in bulk could be substantially lower in cost compared to Li foil because it can be melt-infused into a pre-connected carbon host network.

In addition, bare Li experiences significant thickness changes during charging and discharging, which presents a problem for cell design and operation. Lithium dendrites can grow at the foil surface due to nonuniform electrochemical deposition. Additional cycling will lead to eventual isolation and fragmentation of dendrites, which ultimately consumes available Li and reduces Coulombic efficiency. In contrast, carbon aerogels, due to beneficial mechanical properties and pore morphology, provide superior interfacial stability during cycling, which can enable structures to maintain a constant thickness during operation.

The use of carbon aerogels as a component of an electrode in lithium metal batteries can help homogenize the voltage hysteresis—the difference in voltages of lithium stripping and plating determined by current density, interfacial properties and charge transfer resistance—across the negative electrode. For example, the nanofibrillar structure of the carbon aerogel and its narrow nanoscale pore size distribution can homogenize voltage hysteresis across the electrode. The morphology and geometry of the carbon aerogel, e.g., nanoporosity and narrow pore size distribution, provides a uniform surface for lithium deposition that can reduce dendrite formation and propagation.

In some examples, lithium metal can deposit homogeneously within the carbon aerogel host during charging without formation of dendrites or mossy-like structures. The high electrical conductivity of the carbon aerogel host can lower the overpotential for lithiation and dilithiation, leading to a smooth deposition of lithium even at high current densities and ultimately preserve capacity and maintain high Coulombic efficiency.

In the detailed description of the present disclosure, reference is made to the accompanying drawings, which form a part thereof, and within which are shown by way of illustration specific embodiments by which the invention may be practiced. It is to be understood that other embodiments may be utilized and structural changes may be made without departing from the scope of this disclosure.

As used in this specification and the appended claims, the singular forms “a”, “an”, and “the” include plural referents unless the content clearly dictates otherwise. As used in this specification and the appended claims, the term “or” is generally employed in its sense including “and/or” unless the context clearly dictates otherwise.

As used herein, “about” means approximately or nearly and in the context of a numerical value or range set forth means ±15% of the numerical. In an embodiment, the term “about” can include traditional rounding according to significant figures of the numerical value. In addition, the phrase “about ‘x’ to ‘y’” includes “about ‘x’ to about ‘y’”.

Within the context of the present disclosure, the term “aerogel” or “aerogel material” refers to a gel comprising a framework of interconnected structures, with a corresponding network of interconnected pores integrated within the framework, and containing gases such as air as a dispersed interstitial medium; and which is characterized by the following physical and structural properties (according to nitrogen porosimetry testing) attributable to aerogels: (a) an average pore diameter ranging from about 2 nm to about 100 nm; (b) a porosity of at least 80% or more, and (c) a surface area of about 20 m²/g or more. It can be understood that the inclusion of additives, such as a reinforcement material or an electrochemically active species, may decrease porosity of the resulting aerogel composite. Densification may also decrease porosity of the resulting aerogel composite.

Aerogel materials of the present disclosure thus include any aerogels or other open-celled compounds, which satisfy the defining elements set forth herein, including compounds, which can be otherwise categorized as xerogels, cryogels, ambigels, microporous materials, and the like.

Within the context of the present disclosure, the terms “framework” or “framework structure” refer to the network of interconnected oligomers, polymers, or colloidal particles that form the solid structure of a gel or an aerogel. The polymers or particles that make up the framework structures can have a diameter of about 100 angstroms. However, framework structures of the present disclosure can also include networks of interconnected oligomers, polymers, or colloidal particles of all diameter sizes that form the solid structure within in a gel or aerogel.

Within the context of the present disclosure, the term “dopants” refer to materials having specific properties and technical effects (such as electrochemical properties) on the nanoporous carbon material. The dopants may be dispersed throughout the nanoporous carbon materials. In some instances, the nanoporous carbon material can be doped with elements to nucleate the plating of Li during charging (e.g., doping elements=Au, Si, etc.; or elements such as carbon nanotubes (CNT), MWCNT, graphene or any additional additives to further increase conductivity of the final composite). Doping elements can be added to the nanoporous carbon materials during the synthesis of the nanoporous carbon materials, after the synthesis of the nanoporous carbon materials, or prior to the synthesis of the nanoporous carbon materials (e.g. doping elements can be added to the precursor materials of the nanoporous carbon materials).

Within the context of the present disclosure, the term “aerogel composition” refers to any composite material that includes aerogel material as a component of the composite. Examples of aerogel compositions include, but are not limited to, fiber-reinforced aerogel composites, aerogel-based electrode compositions; aerogel composites including additive elements such as opacifiers and electrochemically active species; aerogel-foam composites; aerogel-polymer composites; and composite materials incorporating aerogel particulates, particles, granules, beads, or powders into a solid or semi-solid material, such as binders, resins, cements, foams, polymers, or similar solid materials.

Aerogel composition includes the composite material is the carbon aerogel and one or more other components contained within, contained by the carbon aerogel. Other components can include dopants as described herein, nanofibers, fillers, inorganic solids, polymers, coatings, metals, etc.

Within the context of the present disclosure, the term “reinforced aerogel composition” refers to aerogel compositions comprising a reinforcing phase within the aerogel material, which either is not part of the aerogel framework or can be modified in a manner to covalently bond to the aerogel framework. The reinforcing phase can be any material that provides increased flexibility, resilience, conformability, or structural stability to the aerogel material. Examples of well-known reinforcing materials include, but are not limited to, open-cell foam reinforcement materials, closed-cell foam reinforcement materials, open-cell membranes, honeycomb reinforcement materials, polymeric reinforcement materials, and fiber reinforcement materials such as discrete fibers, woven materials, non-woven materials, battings, webs, mats, and felts. Additionally, reinforcements may be combined with one or more of the other reinforcing materials and can be oriented continuously throughout or in limited preferred parts of the composition. In some embodiments, no reinforcement phase may be used at all, if the aerogel material and/or aerogel framework is structurally stable on its own (i.e., self-sustaining). This self-sustaining nature of certain carbon aerogels will become clearer as this specification continues.

Within the context of the present disclosure, the term “wet gel” refers to a gel in which the mobile interstitial phase within the network of interconnected pores is primarily comprised of a liquid phase such as a conventional solvent, liquefied gases such as liquid carbon dioxide, or a combination thereof. Aerogels can require the initial production of a wet gel, followed by processing and extraction to replace the mobile interstitial liquid phase in the gel with air or another gas. Examples of wet gels include, but are not limited to, alcogels, hydrogels, ketogels, carbonogels, and any other wet gels known to those in the art.

Within the context of the present disclosure, the terms “additive” or “additive element” refer to materials that can be added to a composition before, during, or after the production of the composition. Additives can be added, for example, to alter or improve desirable properties in an aerogel composition, or to counteract or mitigate undesirable properties in an aerogel composition. Additives can be added to an aerogel composition prior to or during gelation. Additives can also be added to the aerogel composition via atomic layer deposition or chemical vapor deposition (CVD). A particular example of an additive is an electrochemically active species, such as silicon particles.

Within the context of the present disclosure, the term “self-supporting” refers to the ability of an aerogel material or composition to be flexible and/or resilient based primarily on the physical properties of the aerogel. Self-supporting aerogel materials or compositions of the present disclosure can be differentiated from other aerogel materials, such as coatings, which rely on an underlying substrate or reinforcement material to provide flexibility and/or resilience to the material.

Within the context of the present disclosure, the term “density” refers to a measurement of the mass per unit volume of an aerogel material or composition. The term “density” generally refers to the true density of an aerogel material, as well as the bulk density of an aerogel composition. Density units of measurement include kg/m³ and g/cc. The density of an aerogel material or composition may be determined by methods, including, but not limited to: Standard Test Method for Dimensions and Density of Preformed Block and Board-Type Thermal Insulation (ASTM C303, ASTM International, West Conshohocken, Pa.); Standard Test Methods for Thickness and Density of Blanket or Batt Thermal Insulations (ASTM C167, ASTM International, West Conshohocken, Pa.); Determination of the apparent density of preformed pipe insulation (ISO 18098, International Organization for Standardization, Switzerland); Standard Test Methods for Determining Loose and Tapped Bulk Densities of Powders using a Graduated Cylinder (ASTM D7481, ASTM International, West Conshohocken, Pa.); Standard Test Method for Mechanically Tapped Density of Activated Carbon (Powdered and Fine Mesh) (ASTM B527, ASTM International, West Conshohocken, Pa.); or Standard Test Method for Tap Density of Metal Powders and Compounds (ASTM D8176, ASTM International, West Conshohocken, Pa.). Aerogel materials or compositions of the present disclosure have a density of about 1.50 g/cc or less, 1.40 g/cc or less, 1.30 g/cc or less, 1.20 g/cc or less, 1.10 g/cc or less, 1.00 g/cc or less, 0.90 g/cc or less, 0.80 g/cc or less, 0.70 g/cc or less, 0.60 g/cc or less, 0.50 g/cc or less, 0.40 g/cc or less, 0.30 g/cc or less, 0.20 g/cc or less, 0.10 g/cc or less, or in a range between any two of these values.

Production of an aerogel, according to certain embodiments, includes the following steps: i) formation of a solution containing a gel precursor; ii) formation of a gel from the solution; and iii) extracting the solvent from the gel materials to obtain a dried aerogel material. This process is discussed herein, specifically in the context of forming organic aerogels, such as polyimide aerogels. The specific examples and illustrations provided herein are not intended to limit the present disclosure to any specific type of aerogel and/or method of preparation. The present disclosure can include any aerogel formed by any associated method of preparation.

An exemplary solution to produce a polyimide aerogel is formed by combining at least one diamine and at least one dianhydride in a common polar aprotic solvent(s). Additional details regarding polyimide gel/aerogel formation can be found in U.S. Pat. Nos. 7,074,880 and 7,071,287 to Rhine et al.; U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261; Leventis et al., Isocyanate-Derived Organic Aerogels: Polyureas, Polyimides, Polyamides, MRS Proceedings, 1306 (2011), Mrsf10-1306-bb03-01. doi:10.1557/opl.2011.90; Chidambareswarapattar et al., One-step room-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383, each of which is incorporated herein by reference in its entirety. Triamines, tetramines, pentamines, hexamines, etc. can also be used instead of or in addition to diamines or a combination thereof in order to optimize the properties of the gel material. Trianhydrides, tetranhydrides, pentanhydrides, hexanhydrides, can also be used instead of or in addition to dianhydrides or a combination thereof in order to enhance the properties of the gel material. A dehydrating agent and a catalyst can be incorporated into the solution to initiate and drive imidization.

The solution can include additional co-gelling precursors, as well as filler materials and other additives. Filler materials and other additives may be dispensed in the solution at any point before or during the formation of a gel. Filler materials and other additives may also be incorporated into the gel material after gelation through various techniques. The solution comprising the gelling precursors, solvents, catalysts, water, filler materials, and other additives is a homogenous solution, which is capable of effective gel formation under suitable conditions.

Once a solution has been formed, the gel-forming components in the solution can be transitioned into a gel material. The process of transitioning gel-forming components into a gel material comprises an initial gel formation step wherein the gel solidifies up to the gel point of the gel material. The gel point of a gel material may be viewed as the point where the gelling solution exhibits resistance to flow and/or forms a substantially continuous polymeric framework throughout its volume. A range of gel-forming techniques can be used. Examples include, but are not limited to: maintaining the mixture in a quiescent state for a sufficient period of time; adjusting the concentration of a catalyst; adjusting the temperature of the solution; directing a form of energy onto the mixture (ultraviolet, visible, infrared, microwave, ultrasound, particle radiation, electromagnetic); or a combination thereof.

The process of transitioning gel-forming components into a gel material can also include an aging step (also referred to as curing) prior to liquid phase extraction. Aging a gel material after it reaches its gel point can further strengthen the gel framework by increasing the number of cross-linkages within the network. The duration of gel aging can be adjusted to control various properties within the resulting aerogel material. This aging procedure can be useful in preventing potential volume loss and shrinkage during liquid phase extraction. Aging can involve maintaining the gel (prior to extraction) at a quiescent state for an extended period; maintaining the gel at elevated temperatures; adding cross-linkage promoting compounds; or any combination thereof. The preferred temperatures for aging are usually between about 10° C. and about 200° C. The aging of a gel material typically continues up to the liquid phase extraction of the wet-gel material.

The time period for transitioning gel-forming materials into a gel material includes both the duration of the initial gel formation (from initiation of gelation up to the gel point), as well as the duration of any subsequent curing and aging of the gel material prior to liquid phase extraction (from the gel point up to the initiation of liquid phase extraction). The total time period for transitioning gel-forming materials into a gel material can be instantaneous or extend from instantaneous to about 1 minute, from about 1 minute to about several days, about 30 hours or less, about 24 hours or less, about 15 hours or less, about 10 hours or less, about 6 hours or less, about 4 hours or less, about 2 hours or less, about 1 hour or less, about 30 minutes or less, or about 15 minutes or less.

The resulting gel material may be washed in a suitable secondary solvent to replace the primary reaction solvent present in the wet-gel. Such secondary solvents may be linear monohydric alcohols with one or more aliphatic carbon atoms, dihydric alcohols with two or more carbon atoms, branched alcohols, cyclic alcohols, alicyclic alcohols, aromatic alcohols, polyhydric alcohols, ethers, ketones, cyclic ethers or their derivative.

Once a gel material has been formed and processed, the liquid phase of the gel can then be at least partially extracted from the wet-gel using extraction methods, including processing and extraction techniques, to form an aerogel material. Liquid phase extraction, among other factors, is a factor in engineering the characteristics of aerogels, such as porosity and density, as well as related properties such as thermal conductivity and dielectric constant. Aerogels can be obtained when a liquid phase is extracted from a gel in a manner that causes low shrinkage to the porous network and framework of the wet gel.

One method of forming aerogels includes removing the liquid mobile phase from the gel material at a temperature and pressure near or above the critical point of the liquid mobile phase. Once the critical point is reached (near critical) or surpassed (supercritical) (i.e., pressure and temperature of the system is at or higher than the critical pressure and critical temperature respectively), a new supercritical phase appears in the fluid that is distinct from the liquid or vapor phase. The solvent can then be removed without introducing a liquid-vapor interface, capillary pressure, or any associated mass transfer limitations associated with liquid-vapor boundaries. Additionally, the supercritical phase is more miscible with organic solvents in general, thus having the capacity for better extraction. Co-solvents and solvent exchanges are also used to achieve the desired supercritical fluid drying process.

If evaporation or extraction occurs below the supercritical point, capillary forces generated by liquid evaporation can cause shrinkage and pore collapse within the gel material. Maintaining the mobile phase near or above the critical pressure and temperature during the solvent extraction process reduces the negative effects of such capillary forces. In some examples, the use of near-critical conditions just below the critical point of the solvent system may allow production of aerogel materials or compositions with sufficiently low shrinkage, thus producing a commercially viable end-product.

Several additional aerogel extraction techniques include a range of different approaches in the use of supercritical fluids in drying aerogels, as well as ambient drying techniques. For example, Kistler (J. Phys. Chem. (1932) 36: 52-64) describes a simple supercritical extraction process where the gel solvent is maintained above its critical pressure and temperature, thereby reducing evaporative capillary forces and maintaining the structural integrity of the gel network. U.S. Pat. No. 4,610,863 describes an extraction process where the gel solvent is exchanged with liquid carbon dioxide and subsequently extracted at conditions where carbon dioxide is in a supercritical state. U.S. Pat. No. 6,670,402 teaches extracting a liquid phase from a gel via rapid solvent exchange by injecting supercritical (rather than liquid) carbon dioxide into an extractor that has been pre-heated and pre-pressurized to substantially supercritical conditions or above, thereby producing aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically extracting the fluid/sol-gel. U.S. Pat. No. 6,315,971 discloses a process for producing gel compositions comprising: drying a wet gel comprising gel solids and a drying agent to remove the drying agent under drying conditions sufficient to reduce shrinkage of the gel during drying. U.S. Pat. No. 5,420,168 describes a process whereby Resorcinol/Formaldehyde aerogels can be manufactured using a simple air-drying procedure. U.S. Pat. No. 5,565,142 describes drying techniques in which the gel surface is modified to be stronger and more hydrophobic, such that the gel framework and pores can resist collapse during ambient drying or subcritical extraction. Other examples of extracting a liquid phase from aerogel materials can be found in U.S. Pat. Nos. 5,275,796 and 5,395,805.

In some examples, extracting a liquid phase from the wet-gel uses supercritical conditions of carbon dioxide includes: first substantially exchanging the primary solvent present in the pore network of the gel with liquid carbon dioxide; and then heating the wet gel (such as in an autoclave) beyond the critical temperature of carbon dioxide (about 31.06° C.) and increasing the pressure of the system to a pressure greater than the critical pressure of carbon dioxide (about 1070 psig). The pressure around the gel material can be slightly fluctuated to facilitate removal of the supercritical carbon dioxide fluid from the gel. Carbon dioxide can be recirculated through the extraction system to facilitate continual removal of the primary solvent from the wet gel. Finally, the temperature and pressure are slowly returned to ambient conditions to produce a dry aerogel material. Carbon dioxide can also be pre-processed into a supercritical state prior to being injected into an extraction chamber. Extraction can also be performed using any suitable mechanism, for example altering the pressures, timings, and solvent discussed above.

In certain examples of the present disclosure, a dried polyimide aerogel composition can be subjected to one or more heat treatments for a duration of time of 3 hours or more, between 10 seconds and 3 hours, between 10 seconds and 2 hours, between 10 seconds and 1 hour, between 10 seconds and 45 minutes, between 10 seconds and 30 minutes, between 10 seconds and 15 minutes, between 10 seconds and 5 minutes, between 10 seconds and 1 minute, between 1 minute and 3 hours, between 1 minute and 1 hour, between 1 minute and 45 minutes, between 1 minute and 30 minutes, between 1 minute and 15 minutes, between 1 minute and 5 minutes, between 10 minutes and 3 hours, between 10 minutes and 1 hour, between 10 minutes and 45 minutes, between 10 minutes and 30 minutes, between 10 minutes and 15 minutes, between 30 minutes and 3 hours, between 30 minutes and 1 hour, between 30 minutes and 45 minutes, between 45 minutes and 3 hours, between 45 minutes and 90 minutes, between 45 minutes and 60 minutes, between 1 hour and 3 hours, between 1 hour and 2 hours, between 1 hour and 90 minutes, or in a range between any two of these values.

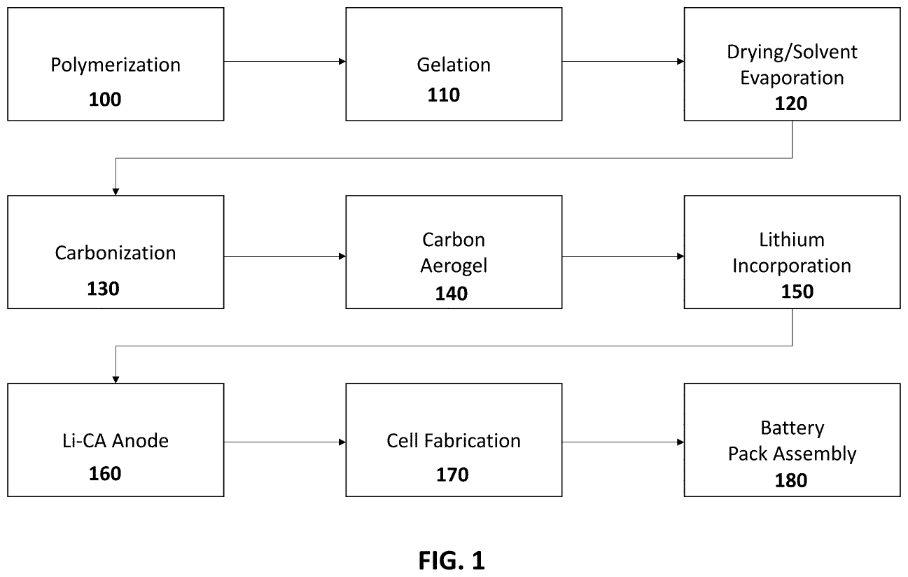

In certain examples, the present disclosure involves the formation and use of nanoporous carbon-based scaffolds or structures, such as carbon aerogels, as electrode materials within an energy storage device, for example as the primary anodic material in a LIB. The pores of the nanoporous scaffold are designed, organized, and structured to accommodate particles of silicon or other metalloid or metal, and expansion of such particles upon lithiation in LIB, for example. Alternatively, the pores of the nanoporous scaffold may be filled with sulfide, hydride, any suitable polymer, or other additive where there is benefit to contacting the additive with an electrically conductive material (i.e., the scaffold/aerogel) to provide for a more effective electrode. An exemplary process utilizing carbon aerogel in a battery application can be seen in FIG. 1. An exemplary carbon aerogel (140) can be prepared following the processes shown in FIGS. 1 (100, 110, 120 and 130). After a carbon aerogel is formed, Lithium is incorporated (150) into the carbon aerogel using the suitable techniques according to the multiple embodiments of the present disclosure to obtain Li-Carbon aerogel (Li-CA) anode (160). According to some embodiments, cell fabrication (170) and battery-pack assembly (180) requires incorporation of Li-Carbon aerogel (Li-CA) anode.

To further expand on the exemplary application within LIBs, when carbon aerogel material is used as the primary anodic material as in examples of the present disclosure, the aerogel nanoporous structure has a narrow pore size distribution, and provides for high electrical conductivity, high mechanical strength, and a morphology and sufficient pore volume (at a final density) to accommodate a high percentage by weight of silicon particles and expansion thereof. Structurally, examples of the present disclosure can have a fibrillar morphology with a strut size that produces the aforementioned narrow pore size distribution and high pore volume, and enhanced connectedness, among other properties. In some examples, an average strut width of the fibrillar morphology of the nanoporous carbon material can be 1 nm, 2 nm, 5 nm, 10 nm, 15 nm, any intervening value (e.g., 7 nm) or in a range between any two of these values (e.g., ranges from about 2 nm to about 10 nm).

In some examples, the surface of the carbon aerogel may be modified via chemical, physical, or mechanical methods in order to enhance performance with electrochemically active species contained within the pores of the carbon aerogel.

Carbon aerogel itself can function as a current collector due to its electrical conductivity and mechanical strength, thus, eliminating the need for a distinct current collector on the cathode side or anode side (when the cathode or anode, respectively, is formed of the carbon aerogel). In the majority of LIBs, aluminum foil or copper foil is required to be coupled to the cathode or anode, respectively, as its current collector. However, removal of one or both of these components, depending on the application of the carbon aerogel, derives additional space for more electrode material, resulting in even greater capacity of the cell/individual electrode and overall greater energy density of the packaged battery system. However, in some examples, existing current collectors may be integrated with the cathode and anode materials of various other examples to augment the aluminum foil's and copper foil's current collection capabilities or capacities.

In some examples, nanoporous carbon-based scaffolds or structures, and specifically the carbon aerogel can be used as the conductive network or current collector on the anode side of an energy storage device. The fully interconnected carbon aerogel network is filled with electrochemically active species, where the electrochemically active species are in direct contact or physically connected to the carbon network. Loading of electrochemically active species is tuned with respect to pore volume and porosity for high and stable capacity and improved energy storage device safety. When utilized on the anode side, the electrochemically active species may include, for example, silicon, graphite, lithium or other metalloids or metals. The anode can comprise nanoporous carbon-based scaffolds or structures, and specifically carbon aerogels.

Within the context of the present disclosure, the term “collector-less” refers to the absence of a distinct current collector that is directly connected to an electrode. As noted, in conventional LIBs, a copper foil is coupled to the anode as its current collector. Electrodes formed from nanoporous carbon-based scaffolds or structures (e.g., carbon aerogels), according to examples of the present disclosure, can be a freestanding structure or otherwise have the capability of being collector-less since the scaffold or structure itself functions as the current collector, due to its high electrical conductivity. Within the electrochemical cell, a collector-less electrode can be connected to form a circuit by embedding solid, mesh, woven tabs during the solution step of making the continuous porous carbon; or by soldering, welding, or metal depositing leads onto a portion of the porous carbon surface. Other mechanisms of contacting the carbon to the remainder of the system are contemplated herein as well. In some examples, the nanoporous carbon-based scaffolds or structures, and specifically a carbon aerogel may be disposed on or otherwise in communication with a dedicated current-collecting substrate (e.g., copper foil, aluminum foil, etc.). In this scenario, the carbon aerogel can be attached to a solid current collector using a conductive adhesive and applied with varying amounts of pressure.

Furthermore, it is contemplated herein that the nanoporous carbon-based scaffolds or structures, and specifically carbon aerogels, can take the form of monolithic structures. When monolithic in nature, the carbon aerogel eliminates the need for any binders; in other words, the anode can be binder-less. As used herein, the term “monolithic” refers to aerogel materials in which a majority (by weight) of the aerogel included in the aerogel material or composition is in the form of a unitary, continuous, interconnected aerogel nanostructure. Monolithic aerogel materials include aerogel materials which are initially formed to have a unitary interconnected gel or aerogel nanostructure, but which can be subsequently cracked, fractured or segmented into non-unitary aerogel nanostructures. Monolithic aerogels may take the form of a freestanding structure or a reinforced (fiber or foam) material. In comparison, using silicon lithiation as an example, silicon incorporated into a monolithic aerogel can be utilized more effectively relative to theoretical capacity, as compared to the same amount of silicon incorporated into a slurry using conventional processes.

Monolithic aerogel materials are differentiated from particulate aerogel materials. The term “particulate aerogel material” refers to aerogel materials in which a majority (by weight) of the aerogel included in the aerogel material is in the form of particulates, particles, granules, beads, or powders, which can be combined together (i.e., via a binder, such as a polymer binder) or compressed together but which lack an interconnected aerogel nanostructure between individual particles. Collectively, aerogel materials of this form will be referred to as having a powder or particulate form (as opposed to a monolithic form). It should be noted that despite an individual particle of a powder having a unitary structure, the individual particle is not considered herein as a monolith. Integration of aerogel powder into an electrochemical cell typically preparation of a paste or slurry from the powder, casting and drying onto a substrate, and may optionally include calendaring.

Particulate aerogel materials, e.g., aerogel beads, provide certain advantages. For example, particulate materials can be used as a direct replacement for other materials such as graphite in LIB anodes and anode manufacturing processes. Particulate materials can also provide improved lithium ion diffusion rates due to shorter diffusion paths within the particulate material. Particulate materials can also allow for electrodes with enhanced packing densities, e.g., by tuning the particle size and packing arrangement. Particulate materials can also provide improved access to silicon due to inter-particle and intra-particle porosity.

Within the context of the present disclosure, the terms “binder-less” or “binder-free” (or derivatives thereof) refer to a material being substantially free of binders or adhesives to hold that material together. For example, a monolithic nanoporous carbon material is free of binder since its framework is formed as a unitary, continuous interconnected structure. Advantages of being binder-less include avoiding any effects of binders, such as on electrical conductivity and pore volume. On the other hand, aerogel particles require a binder to hold together to form a larger, functional material; such larger material is not contemplated herein to be a monolith. In addition, this “binder-free” terminology does not exclude all uses of binders. For example, a monolithic aerogel, according to the present disclosure, may be secured to another monolithic aerogel or a non-aerogel material by disposing a binder or adhesive onto a major surface of the aerogel material. In this way, the binder is used to create a laminate composite and provide electrical contact to a current collector, but the binder has no function to maintain the stability of the monolithic aerogel framework itself.

Furthermore, monolithic polymeric aerogel materials or compositions of the present disclosure may be compressed up to 95% strain without significant breaking or fracturing of the aerogel framework, while densifying the aerogel. In some examples, the compressed polymeric aerogel materials or compositions are subsequently carbonized using varying methods, to form nanoporous carbon materials. It can be understood that amount of compression affects thickness of the resulting carbon material, where the thick-ness has an effect on capacity. The examples, described infra, will illustrate varying thicknesses that are formed and contemplated by the present disclosure, where thickness is adjustable based on compression. As such, thickness of a composite (typically compressed) can be about 1-1000 micrometers, or any narrower range therein based on benefits needed of the final composite. The present disclosure also contemplates a powder or particle form of the carbon aerogel, where a binder would be needed and a specific particle size needed. A range of particle sizes may be about 1-50 micrometers. Compression of a coating can include, or consist of, polymer aerogel beads that are subsequently carbonized.

Nanoporous carbons, such as carbon aerogels, according to the present disclosure, can be formed from any suitable organic precursor materials. Examples of such materials include, but are not limited to, RF, PF, PI, polyamides, polyacrylate, polymethyl methacrylate, acrylate oligomers, polyoxyalkylene, polyurethane, polyphenol, polybutadiane, trialkoxysilyl-terminated polydimethylsiloxane, polystyrene, polyacrylonitrile, polyfurfural, melamine-formaldehyde, cresol formaldehyde, phenol-furfural, polyether, polyol, polyisocyanate, polyhydroxybenze, polyvinyl alcohol dialdehyde, polycyanurates, polyacrylamides, various epoxies, agar, agarose, chitosan, and combinations and derivatives thereof. Any precursors of these materials may be used to create and use the resulting materials. In some examples, the carbon aerogel is formed from a pyrolyzed/carbonized polyimide-based aerogel, i.e., the polymerization of polyimide. Even more specifically, the polyimide-based aerogel can be produced using one or more methodologies described in U.S. Pat. Nos. 7,071,287 and 7,074,880 to Rhine et al., e.g., by imidization of poly(amic) acid and drying the resulting gel using a supercritical fluid. Other adequate methods of producing polyimide aerogels (and carbon aerogels derived therefrom) are contemplated herein as well, for example as described in U.S. Pat. No. 6,399,669 to Suzuki et al.; U.S. Pat. No. 9,745,198 to Leventis et al.; Leventis et al., Polyimide Aerogels by Ring-Opening Metathesis Polymerization (ROMP), Chem. Mater. 2011, 23, 8, 2250-2261; Leventis et al., Isocyanate-Derived Organic Aerogels: Polyureas, Polyimides, Polyamides, MRS Proceedings, 1306 (2011), Mrsf10-1306-bb03-01. doi:10.1557/opl.2011.90; Chidambareswarapattar et al., One-step room-temperature synthesis of fibrous polyimide aerogels from anhydrides and isocyanates and conversion to isomorphic carbons, J. Mater. Chem., 2010, 20, 9666-9678; Guo et al., Polyimide Aerogels Cross-Linked through Amine Functionalized Polyoligomeric Silsesquioxane, ACS Appl. Mater. Interfaces 2011, 3, 546-552; Nguyen et al., Development of High Temperature, Flexible Polyimide Aerogels, American Chemical Society, proceedings published 2011; Meador et al., Mechanically Strong, Flexible Polyimide Aerogels Cross-Linked with Aromatic Triamine, ACS Appl. Mater. Interfaces, 2012, 4 (2), pp 536-544; Meador et al., Polyimide Aerogels with Amide Cross-Links: A Low Cost Alternative for Mechanically Strong Polymer Aerogels, ACS Appl. Mater. Interfaces 2015, 7, 1240-1249; Pei et al., Preparation and Characterization of Highly Cross-Linked Polyimide Aerogels Based on Polyimide Containing Trimethoxysilane Side Groups, Langmuir 2014, 30, 13375-13383. The resulting polyimide aerogel would then be pyrolyzed to form a polyimide-derived carbon aerogel.

Carbon aerogels of the present disclosure, e.g., polyimide-derived carbon aerogels, can have a residual nitrogen content of at least about 4 wt %. For example, carbon aerogels can have a residual nitrogen content of at least about 0.1 wt %, at least about 0.5 wt %, at least about 1 wt % at least about 2 wt %, at least about 3 wt %, at least about 4 wt %, at least about 5 wt %, at least about 6 wt %, at least about 7 wt %, at least about 8 wt %, at least about 9 wt %, at least about 10 wt %, or in a range between any two of these values.

In examples of the present disclosure, a dried polymeric aerogel composition can be subjected to a treatment temperature of 200° C. or above, 400° C. or above, 600° C. or above, 800° C. or above, 1000° C. or above, 1200° C. or above, 1400° C. or above, 1600° C. or above, 1800° C. or above, 2000° C. or above, 2200° C. or above, 2400° C. or above, 2600° C. or above, 2800° C. or above, or in a range between any two of these values, for carbonization of the organic (e.g., polyimide) aerogel. In exemplary embodiments, a dried polymeric aerogel composition can be subjected to a treatment temperature in the range of about 1000° C. to about 1100° C., e.g., at about 1050° C. Without being bound by theory, it is contemplated herein that the electrical conductivity of the aerogel composition increases with carbonization temperature.

Within the context of the present disclosure, the term “electrical conductivity” refers to a measurement of the ability of a material to conduct an electric current or other allow the flow of electrons therethrough or therein. Electrical conductivity is specifically measured as the electric conductance/susceptance/admittance of a material per unit size of the material. It is typically recorded as S/m (Siemens/meter) or S/cm (Seimens/centimeter). The electrical conductivity or resistivity of a material may be determined by methods known in the art, for example including, but not limited to: In-line Four Point Resistivity (using the Dual Configuration test method of ASTM F84-99). Within the context of the present disclosure, measurements of electrical conductivity are acquired according to ASTM F84—resistivity (R) measurements obtained by measuring voltage (V) divided by current (I), unless otherwise stated. Aerogel materials or compositions of the present disclosure can have an electrical conductivity of about 1 S/cm or more, about 5 S/cm or more, about 10 S/cm or more, 20 S/cm or more, 30 S/cm or more, 40 S/cm or more, 50 S/cm or more, 60 S/cm or more, 70 S/cm or more, 80 S/cm or more, or in a range between any two of these values.

Within the context of the present disclosure, the term “electrochemically active species” refers to an additive that can be used, e.g., in small quantities as a dopant, and is capable of accepting and releasing ions within an energy storage device. Using LIB s as an example, an electrochemically active species within the anode accepts lithium ions during charge and releases lithium ions during discharge. The electrochemically active species can be stabilized within the anode by having a direct/physical connection with the nanoporous carbon. The nanoporous carbon network can form interconnected structures around the electrochemically active species. The electrochemically active species is connected to the nanoporous carbon at a plurality of points. An example of an electrochemically active species is silicon, which expands upon lithiation and can crack or break. However, because silicon has multiple connection points with the nanoporous carbon (aerogel), silicon can be retained and remain active within the nanoporous structure, e.g., within the pores or otherwise encased by the structure, even upon breaking or cracking. The electrochemically active species can be referred to as electrically active additives and can be used to promote infiltration and plating. For example, as a material for Li-metal anodes, silicon doping can be used to promote Li infiltration and initiate lithium plating. Besides silicon, other electrically active additives include gold, silver, zinc, magnesium, platinum, aluminum, tin, copper, nickel, and other dopants described herein. In some examples, an electrochemically active material can be used in small quantities as a dopant to seed lithium plating within the porosity of the carbon nanostructure.

Within the context of the present disclosure, the terms “compressive strength”, “flexural strength”, and “tensile strength” refer to the resistance of a material to breaking or fracture under compression forces, flexure or bending forces, and tension or pulling forces, respectively. These strengths are specifically measured as the amount of load/force per unit area resisting the load/force. It can be recorded as pounds per square inch (psi), megapascals (MPa), or gigapascals (GPa). Among other factors, the compressive strength, flexural strength, and tensile strength of a material collectively contribute to the material's structural integrity, which is beneficial, for example, to withstand volumetric expansion of silicon particles during lithiation in a LIB. Referring specifically to Young's modulus, which is an indication of mechanical strength, the modulus may be determined by methods known in the art, for example including, but not limited to: Standard Test Practice for Instrumented Indentation Testing (ASTM E2546, ASTM International, West Conshocken, Pa.); or Standardized Nanoindentation (ISO 14577, International Organization for Standardization, Switzerland). Within the context of the present disclosure, measurements of Young's modulus are acquired according to ASTM E2546 and ISO 14577, unless otherwise stated. In certain embodiments, aerogel materials or compositions of the present disclosure have a Young's modulus of about 0.2 GPa or more, 0.4 GPa or more, 0.6 GPa or more, 1 GPa or more, 2 GPa or more, 4 GPa or more, 6 GPa or more, 8 GPa or more, or in a range between any two of these values.

Within the context of the present disclosure, the term “pore size distribution” refers to the statistical distribution or relative amount of each pore size within a sample volume of a porous material. A narrower pore size distribution refers to a relatively large proportion of pores at a narrow range of pore sizes, thus enhancing the amount of pores that can surround the electrochemically active species and maximizing use of the pore volume. Conversely, a broader pore size distribution refers to relatively small proportion of pores at a narrow range of pore sizes. As such, pore size distribution can be measured as a function of pore volume and recorded as a unit size of a full width at half max of a predominant peak in a pore size distribution chart. The pore size distribution of a porous material may be determined by methods known in the art, for example including, but not limited to, surface area and porosity analyzer by nitrogen adsorption and desorption from which pore size distribution can be calculated. Within the context of the present disclosure, measurements of pore size distribution are acquired according to this method, unless otherwise stated. In some examples, aerogel materials or compositions of the present disclosure have a relatively narrow pore size distribution (full width at half max) of about 50 nm or less, 45 nm or less, 40 nm or less, 35 nm or less, 30 nm or less, 25 nm or less, 20 nm or less, 15 nm or less, 10 nm or less, 5 nm or less, or in a range between any two of these values.

Within the context of the present disclosure, the term “pore volume” refers to the total volume of pores within a sample of porous material. Pore volume is specifically measured as the volume of void space within the porous material, where that void space may be measurable and/or may be accessible by another material, for example an electrochemically active species such as silicon particles. It can be recorded as cubic centimeters per gram (cm³/g or cc/g). The pore volume of a porous material may be determined by methods known in the art, for example including, but not limited to, surface area and porosity analyzer by nitrogen adsorption and desorption from which pore volume can be calculated. Within the context of the present disclosure, measurements of pore volume are acquired according to this method, unless otherwise stated. In certain examples, aerogel materials or compositions of the present disclosure (without incorporation of electrochemically active species, e.g., silicon particles) have a relatively large pore volume of about 0.5 cc/g or more, 1 cc/g or more, 1.5 cc/g or more, 2 cc/g or more, 2.5 cc/g or more, 3 cc/g or more, 3.5 cc/g or more, 4 cc/g or more, or in a range between any two of these values. In other embodiments, aerogel materials or compositions of the present disclosure (with incorporation of electrochemically active species, e.g., silicon particles) have a pore volume of about 0.10 cc/g or more, 0.3 cc/g or more, 0.6 cc/g or more, 0.9 cc/g or more, 1.2 cc/g or more, 1.5 cc/g or more, 1.8 cc/g or more, 2.1 cc/g or more, 2.4 cc/g or more, 2.7 cc/g or more, 3.0 cc/g or more, 3.3 cc/g or more, 3.6 cc/g or more, or in a range between any two of these values.

Within the context of the present disclosure, the term “porosity” refers to a volumetric ratio of pores that does not contain another material (e.g., an electrochemically active species such as silicon particles) bonded to the walls of the pores. For clarification and illustration purposes, it should be noted that within the specific implementation of silicon-doped carbon aerogel as the primary anodic material in a LIB, porosity refers to the void space after inclusion of silicon particles. Porosity may be determined by methods known in the art, for example including, but not limited to, the ratio of the pore volume of the aerogel material to its bulk density. Within the context of the present disclosure, measurements of porosity are acquired according to this method, unless otherwise stated. In certain embodiments, aerogel materials or compositions of the present disclosure have a porosity of about 90% or less, 80% or less, 70% or less, 60% or less, 50% or less, 40% or less, 30% or less, 20% or less, 10% or less, or in a range between any two of these values.

It should be noted that pore volume and porosity are different measures for the same property of the pore structure, namely the “empty space” within the pore structure. For example, when silicon is used as the electrochemically active species surrounded within the pores of the nanoporous carbon material, pore volume and porosity refer to the space that is “empty”, namely the space not utilized by the carbon or the electrochemically active species. As will be seen, densification, e.g., by compression, of the pre-carbonized nanoporous material can also have an effect on pore volume and porosity, among other properties.

Within the context of the present disclosure, the term “pore size at max peak from distribution” refers to the value at the discernible peak on a graph illustrating pore size distribution. Pore size at max peak from distribution is specifically measured as the pore size at which the greatest percentage of pores is formed. It can be recorded as any unit length of pore size, for example μm or nm. The pore size at max peak from distribution may be determined by methods known in the art, for example including, but not limited to, surface area and porosity analyzer by nitrogen adsorption and desorption from which pore size distribution can be calculated and pore size at max peak can be determined. Within the context of the present disclosure, measurements of pore size at max peak from distribution are acquired according to this method, unless otherwise stated. Aerogel materials or compositions of the present disclosure can have a pore size at max peak from distribution of about 150 nm or less, 140 nm or less, 130 nm or less, 120 nm or less, 110 nm or less, 100 nm or less, 90 nm or less, 80 nm or less, 70 nm or less, 60 nm or less, 50 nm or less, 40 nm or less, 30 nm or less, 20 nm or less, 10 nm or less, 5 nm or less, 2 nm or less, or in a range between any two of these values.

Within the context of the present disclosure, the term “strut width” refers to the average diameter of nanostruts, nanorods, nanofibers, or nanofilaments that form an aerogel having a fibrillar morphology. It can be recorded as any unit length, for example μm or nm. The strut width may be determined by methods known in the art, for example including, but not limited to, scanning electron microscopy image analysis. Within the context of the present disclosure, measurements of strut width are acquired according to this method, unless otherwise stated. Aerogel materials or compositions of the present disclosure can have a strut width of about 10 nm or less, 9 nm or less, 8 nm or less, 7 nm or less, 6 nm or less, 5 nm or less, 4 nm or less, 3 nm or less, 2 nm or less, or in a range between any two of these values. Smaller strut widths, such as those in the range of about 2-5 nm, permit a greater amount of struts to be present within the network and thus contact the electrochemically active species, in turn allowing more of the electrochemically active species to be present within the composite. This increases electrical conductivity and mechanical strength.

Within the context of the present disclosure, the term “fibrillar morphology” refers to the structural morphology of a nanoporous carbon (e.g., aerogel) being inclusive of struts, rods, fibers, or filaments. For example, choice of solvent, such as dimethylacetamide (DMAC), can affect the production of such morphology. Further, when the carbon aerogel is derived from polyimides, a crystalline polyimide results from the polyimide forming a linear polymer. Some examples of the present disclosure were observed surprisingly to include a fibrillar morphology as an interconnected polymeric structure, where a long linear structure was anticipated, based on the known behavior of the polyimide precursors. In comparison, the product form of the nanoporous carbon can alternatively be particulate in nature or powder wherein the fibrillar morphology of the carbon aerogel persists. In some examples, a fibrillar morphology can provide certain benefits over a particulate morphology, such as mechanical stability/strength and electrical conductivity, particularly when the nanoporous carbon is implemented in specific applications, for example as the anodic material in a LIB. It should be noted that this fibrillar morphology can be found in nanoporous carbons of both a monolithic form and a powder form; in other words, a monolithic carbon can have a fibrillar morphology, and aerogel powder/particles can have a fibrillar morphology. Furthermore, when the nanoporous carbon material contains additives, such as silicon or others, the fibrillar nanostructure inherent to the carbon material is preserved and serves as a bridge between additive particles.

Within the context of the present disclosure, the term “cycle life” refers to the number of complete charge/discharge cycles that an anode or a battery (e.g., LIB) is able to support before its capacity falls under about 80% of its original rated capacity. Cycle life may be affected by a variety of factors, for example mechanical strength of the underlying substrate (e.g., carbon aerogel) and maintenance of interconnectivity of the aerogel. It is noted that these factors actually remaining relatively unchanged over time is a surprising aspect of certain examples of the present disclosure. Cycle life may be determined by methods known in the art, for example including, but not limited to, cycle testing, where battery cells are subject to repeated charge/discharge cycles at predetermined current rates and operating voltage. Within the context of the present disclosure, measurements of cycle life are acquired according to this method, unless otherwise stated. Energy storage devices, such as batteries, or electrode thereof, can have a cycle life of about 25 cycles or more, 50 cycles or more, 75 cycles or more, 100 cycles or more, 200 cycles or more, 300 cycles or more, 500 cycles or more, 1000 cycles or more, or in a range between any two of these values.

Within the context of the present disclosure, the term “capacity” refers to the amount of specific energy or charge that a battery is able to store. In some examples, capacity refers to reversible capacity. Capacity is specifically measured as the discharge current that the battery can deliver over time, per unit mass. It can be recorded as ampere-hours or milliampere-hours per gram of total electrode mass, Ah/g or mAh/g. The capacity of a battery (and a anode in particular) may be determined by methods known in the art, for example including, but not limited to: applying a fixed constant current load to a fully charged cell until the cell's voltage reaches the end of discharge voltage value or that applying a fixed constant current load with a specific amount of time; the time to reach end of discharge voltage or the specific amount of time applied with fixed current multiplied by the constant current is the discharge capacity; by dividing the discharge capacity by the weight of electrode material or volume, specific and volumetric capacities can be determined. Within the context of the present disclosure, measurements of capacity are acquired according to this method, unless otherwise stated. Aerogel materials or compositions of the present disclosure can have an anode capacity of about 100 mAh/g or more, 150 mAh/g or more, 200 mAh/g or more, 300 mAh/g or more, 400 mAh/g or more, 500 mAh/g or more, 600 mAh/g or more, 700 mAh/g or more, 800 mAh/g or more, 900 mAh/g or more, 1000 mAh/g or more, 1100 mAh/g or more, 1200 mAh/g or more, 1300 mAh/g or more, 1400 mAh/g or more, 1500 mAh/g or more, 1600 mAh/g or more, 1700 mAh/g or more, 1800 mAh/g or more, 1900 mAh/g or more, 2000 mAh/g or more, 2500 mAh/g or more, 3000 mAh/g or more, or in a range between any two of these values or any intervening value (e.g. 520 mAh/g).

It is contemplated herein that the pore size is tunable as needed. There are five primary methods of adjusting pore size taught herein. First, the amount of solids content, specifically the amount of polyimide precursor monomers (e.g., aromatic or aliphatic diamine and aromatic or aliphatic dianhydride), can adjust pore size. Smaller pore sizes result from a greater amount of solids per unit volume of fluid, due to less room being available such that inter-connection takes place more closely. It should be noted that strut width does not change measurably, regardless of the amount of solids used. The amount of solids relates more so to how dense the network will be.

Adjusting pore size can be accomplished with the use of radiation (e.g., radio wave, microwave, infrared, visible light, ultraviolet, X-ray, gamma ray) on the composite in either polyimide state or in carbon state. Radiation has an oxidizing effect, resulting in an increase in surface area, increase in pore size, and broadening of pore size distribution. Thirdly, pore size is affected by a macroscopic compression of the polyimide composite. In some examples, pore size reduces with compression.

Adjusting pore size can be accomplished with ion bombardment of the composite in either polyimide state or carbon state. The effect of ion bombardment depends on the method designated. For example, there is additive ion bombardment (e.g., CVD), where something is added, resulting in a reduction of pore size. There is also destructive ion bombardment, where pore size would increase. Finally, pore size can be adjusted (increase or decrease) with heat treatment under different gas environments, for example presence of carbon dioxide or carbon monoxide, chemically active environments such as mixing with sodium or potassium hydroxides, hydrogen reducing environments, etc. A carbon dioxide environment, for example, is known to make activated carbon, where in instances of activation, mass is removed, pore size increases, and surface area increases.

Lithium can be used with carbon aerogels in a variety of manners including being pre-deposited by ex situ lithium plating or melt infusion prior to cell assembly. For pre-deposited lithium in carbon aerogel, examples include carbon aerogel pre-treated to promote Li infiltration and carbon aerogel pre-doped/pre-coated with Si (a known additive to promote Li infiltration). For carbon aerogel lithiated (or plated) in situ during formation, examples include providing enough Li to be available in the electrolyte and cathode that upon initial charging, the carbon aerogel becomes plated such that no more than 50% of Li is lost to SEI formation.

Lithium in carbon aerogel can have several forms including free-standing carbon aerogel monolith, carbon aerogel on copper current collector, carbon aerogel on lithium metal, and carbon aerogel beads. Carbon aerogel has high electrical conductivity and can serve as a current collector. Beads can be used in standard battery manufacturing slurry/casting methods. Beads of certain dimension and particle size distribution can be manufactured and then infiltrated with Li metal in bulk on individual beads and post casted beads as electrodes.

For carbon aerogels, infiltration of lithium can be accomplished via melt infusion and electrodeposition. The narrow and controllable particle size distribution helps provide uniform lithium deposition during charging, which can help reduce or prevent dendrite formation. In one embodiment where the carbon aerogel resides between the lithium metal and separator, during operation of the battery, the carbon aerogel is reduced upon charging and Li ions—from the Li metal underlayer and electrolyte-deposit on the surface of the carbon aerogel. Subsequently, upon discharge, the stored Li ions in the carbon aerogel are released and the Li metal underlayer can continue to resupply Li ions as needed while not allowing dendrites to propagate. The carbon aerogel moderator/barrier layer is prepared with a desired surface area, pore size, and pore size distribution to achieve high capacity, long cycle life, good rate capability and improved safety.

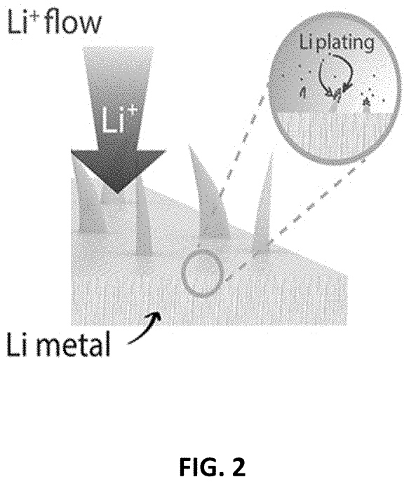

FIG. 2 displays an example of dendritic growth at the surface of lithium metal. The growth of Li dendrites upon charging and discharging, as shown in FIG. 2, hampers the use of Li anodes and compromises the life and safety of the battery. The geometry of the carbon aerogel—nanoporosity and narrow pore size distribution—provides a uniform surface for Li deposition that prohibits dendrite formation and propagation. Accordingly, carbon aerogels can act as a barrier layer to prevent dendritic growth at the surface of Li metal. Carbon aerogels can provide a controlled Li diffusion interface that suppresses the growth of Li dendrites. Traditionally, the growth of Li dendrites can be suppressed by regulating the Li⁺ ion flux during charge/discharge cycling at current densities between 2 and 4 mA cm⁻². Carbon aerogels acting as a barrier layer may permit charge/discharge cycles at higher current densities.

The system can include a nanoporous carbon material with a pore structure and lithium metal disposed adjacent to the nanoporous carbon material. The lithium metal disposed adjacent to the nanoporous carbon material can be a layer of nanoporous carbon material electrically connected to the lithium metal. The layer of nanoporous carbon material can be coated on the lithium metal or can be a monolith bonded to the lithium metal. The nanoporous carbon material can be coated on the lithium metal in a particulate form. In some examples, such as when the system is an electrical energy storage device (e.g., a battery), the nanoporous carbon material resides between the lithium metal and separator.

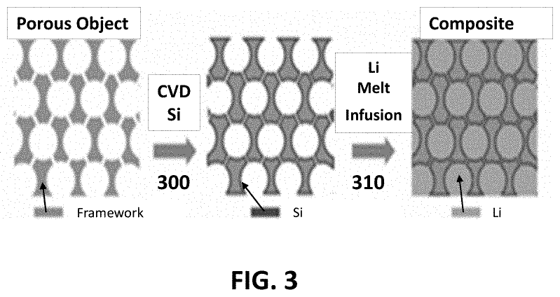

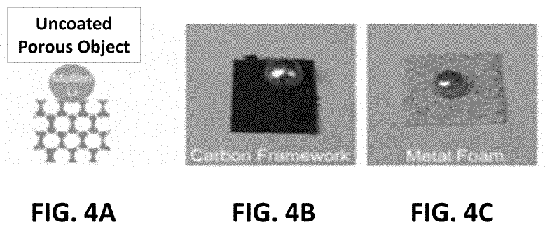

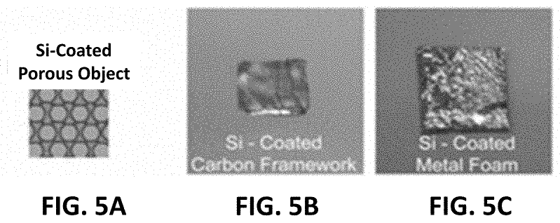

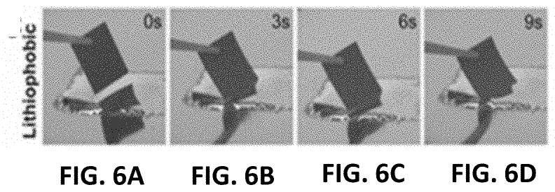

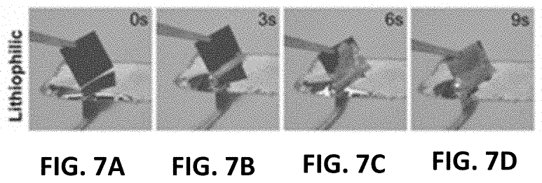

FIGS. 3-7D display schematic and optical images of Li encapsulation by melt infusion. FIG. 3 displays a schematic illustration of a design of a Li-scaffold composite, in accordance with one aspect of the disclosure. FIG. 5A, 5B, 5C and FIG. 4A, 4B, 4C display a lithium wetting property of various porous materials with and without the Si coating, respectively. FIG. 6A-6D and FIG. 7A-7D display time-lapse images of a lithium melt-infusion process for lithiophobic and lithiophilic materials, respectively. Composite lithium metal anode can be produced by melt infusion of lithium into a 3D conducting scaffold with lithiophilic coating. Here, a stable lithium-scaffold composite electrode is developed by lithium melt infusion into a 3D porous carbon matrix with “lithiophilic” coating-silicon. Li easily and quickly flows into the fiber layer region and occupies the empty spaces. Lithium is uniformly entrapped on the matrix surface and in the 3D structure. The resulting composite electrode possesses a high conductive surface area and excellent structural stability upon galvanostatic cycling. Stable cycling of this composite electrode can be achieved with small Li plating/stripping over potential (<90 mV) at a high current density of 3 mA/cm² over 80 cycles.

In some examples, the system such as energy storage system (e.g., a battery) pore structure of the nanoporous carbon material can include fibrillary morphology and an array of pores, such that the array of pores surround lithium metal. In some examples, the lithium metal is plated (ex situ or in situ) on the nanoporous carbon material or is melt infused into the pore structure of the nanoporous carbon material. The nanoporous carbon material can be in a particulate form as well as be a monolith. In some examples, the nanoporous carbon material is a carbon aerogel, such as a polyimide-derived carbon aerogel. The pores of the nanoporous carbon material can form interconnected structures around the lithium metal, and the lithium metal and pore walls of each pore in which the lithium metal is surrounded can be interconnected by a plurality of connection points.

FIG. 3 displays heating Li above its melting temperature and the scaffold absorbing the Li (310). Chemical vapor deposition (CVD) (300) can be used to coat a thin layer of Si onto the scaffold surface or that other metals and metals oxides such as ZnO can be coated onto the scaffold surface via different methods to assist the melt infusion process. As shown in FIG. 4A-4C, the molten Li droplet tends to ball up and avoid contact with surfaces without any modification (e.g. carbon framework, metal foam) which suggests unfavorable wettability and a “lithiophobic” effect. For surface-modified objects as shown in FIG. 5A-5C (e.g. Si-coated carbon framework, Si-coated metal foam), the Si coating reacts with molten Li. Li easily and quickly flows into the fiber layer region and occupies the empty spaces—the Si layer functioning as a lithiophilic coating with favorable wettability. FIG. 6A-6D and FIG. 7A-7D displays a sequence of the time-lapse images of the Li melt-infusion process. For unmodified carbon framework, molten Li could not wet its surface (FIG. 6A-6D). In comparison, the Si-coated carbon framework shows good wettability as molten Li quickly flows into the empty spaces (FIG. 7A-7D).

The present disclosure includes a method of controlling current at an interface in an energy storage system by disposing lithium metal adjacent to a nanoporous carbon material, such as a carbon aerogel. The carbon aerogel can be prepared to have high surface area, narrow pore size distribution, nanometer porosity, and high electrical conductivity. Disposing lithium metal adjacent to a nanoporous carbon material can include filling at least a portion of a void space in the nanoporous carbon material with the lithium metal, electrically connecting a layer of nanoporous carbon material to the lithium metal, and/or infiltrating a fluid into the void space of the nanoporous carbon material. Lithium metal can deposit homogeneously within the carbon aerogel host without formation of dendrites or mossy-like structures. In some examples, electrically connecting a layer of nanoporous carbon material to the lithium metal comprises coating the nanoporous carbon material on the lithium metal. The high electrical conductivity of the nanoporous carbon material can also prevent Li dendrite growth at high current densities without degradation of capacity or Coulombic efficiency.

The present disclosure includes an electrical energy storage device with at least one anode as described herein, at least one cathode, and an electrolyte with lithium ions. The electrical energy storage device can have a first cycle efficiency (i.e., a cell's coulombic efficiency from the first charge and discharge) of at least 10%, 20%, 30%, 40%, 50%, 60%, 70%, any intervening value (e.g., 65%) or in a range between any two of these values (e.g., ranges from about 30% to about 50%). As previously described herein, reversible capacity can be at least 150 mAh/g. The at least one cathode can be selected from the group consisting of conversion cathodes such as sulfur for lithium-sulfur batteries and oxygen/air for lithium air batteries, and intercalation cathodes such as phosphates and transition metal oxides.

### EXAMPLES

### Example 1. Carbon Aerogel as a Li Ion Moderator and Barrier Layer for Li Metal Batteries

In Example 1, Li metal foil, nominally 50 microns in thickness, is coated with a layer of carbon aerogel ranging in thickness between 10 and 200 microns. The carbon aerogel is pre-lithiated with concentrated electrolyte and then positioned between the Li metal foil and the separator. During operation the carbon aerogel is reduced upon charging and Li ions—from the Li metal underlayer and electrolyte-deposit on the surface of the carbon aerogel. Subsequently, upon discharge, the stored Li ions in the carbon aerogel are released and the Li metal underlayer can continue to resupply Li ions as needed. The geometry of the carbon aerogel—nanoporosity and narrow pore size distribution—provides a uniform surface for Li deposition that prohibits dendrite formation and propagation. The carbon aerogel is prepared either as free-standing film or as a fiber-reinforced composite. The carbon aerogel moderator/barrier layer is prepared with a desired surface area, pore size, and pore size distribution in order to achieve high capacity, long cycle life, good rate capability and improved safety. If the above solution is used with traditional Li metal oxide based cathodes, such as LMO, LCO, NMC, etc., specific energy densities greater than 400 Wh/kg and volumetric energy densities greater than 800 Wh/L are achievable. When combined with next generation conversion cathode systems, including Li-sulfur and Li-air, energy densities greater than 600 Wh/kg (1000 Wh/L) are possible.

The carbon aerogel can be further enhanced by carbonization temperature, surface chemistry, pre-doping, and/or post-carbonization doping.

### Example 2. 3D Monolithic Carbon Aerogel Anode Network for Li Metal Batteries

In Example 2, carbon aerogel monolith is prepared so that the surface area, pore size, pore size distribution and pore volume act as an anode substrate or host for Li plating and stripping. For bare copper foil Li anodes, when Li is regenerated during charging, Li dendrites will grow at the foil surface due to non-uniform electrochemical deposition. Additional cycling will lead to eventual isolation and fragmentation of dendrites, which ultimately consumes available Li and reduces Coulombic efficiency. The carbon aerogel in Example 2 is prepared to have high surface area, narrow pore size distribution, nanometer porosity, and high electrical conductivity. Li metal can deposit homogeneously within the carbon aerogel host without formation of dendrites or mossy-like structures. The high electrical conductivity of the carbon aerogel host will also prevent Li dendrite growth at high current densities without degradation of capacity or Coulombic efficiency.

In some instances, the carbon aerogel can be pre-doped with elements to nucleate the plating of Li during charging [doping elements=Au, Si, etc.; or elements such as carbon nanotubes (CNT), MWCNT, graphene or any additional additives to further increase conductivity of the final composite]. Pre-doping of the carbon aerogel can occur during the synthesis of the carbon aerogel precursor polymer aerogel, doping of the precursor polymer aerogel, or doping directly into the carbon aerogel post synthesis. Li can be loaded into the carbon aerogel via (i) melt infusion, (ii) ex situ electrochemical Li plating or (iii) in situ plating (a.k.a., anode-less anode). The carbon aerogel material is then physically attached to a copper current collector. In some instances, the carbon aerogel has sufficient electrical conductivity to not require use of a current collector, and because the carbon aerogel network is continuous and free-standing, no binder nor additional conductive carbon are needed. A collector-less approach can provide additional weight and cost savings in order to maximize energy density, minimize cost and simplify battery manufacturing.

In some instances, the topmost surface of the carbon aerogel monolith can be further coated to yield a pinhole free, stable sealant layer through which electrolyte cannot penetrate and SEI formation only occurs at the surface and not inside the carbon aerogel. The sealant layer is thin and Li permeable and can be comprised of oxides, fluorides, phosphates, carbon, ceramics, etc.

In some instances, the carbon aerogel can be in the form a bead or powder with controllable particle size and particle size distribution. The bead itself has the controllable features inherent to the carbon aerogel, including surface area, pore size/distribution, and pore volume. The carbon aerogel beads can be used in traditional slurry practices to manufacture copper coated electrodes. In some instances, the particles can individually be coated with a sealant layer to further improves against capacity and Coulombic efficiency degradation.

1. A system comprising:
a nanoporous carbon material with a pore structure; and
lithium metal disposed adjacent to the nanoporous carbon material.

2. The system of claim 1, wherein the lithium metal disposed adjacent to the nanoporous carbon material comprises a layer of nanoporous carbon material electrically connected to the lithium metal.

3. The system of claim 2, wherein the layer of nanoporous carbon material is coated on the lithium metal and positioned between the metal and a separator.

4. The system of claim 3, wherein the nanoporous carbon material is in a particulate form.

5. The system of claim 2, wherein the layer of nanoporous carbon material is a monolith bonded to the lithium metal.

6. A system comprising:
a nanoporous carbon material comprising:
a pore structure comprising a fibrillar morphology and an array of pores, wherein the array of pores is surrounding lithium metal.

7. The system of claim 6, wherein the lithium metal is plated on the nanoporous carbon material.

8. The system of claim 6, wherein the lithium metal is melt infused into the pore structure of the nanoporous carbon material.

9. The system of claim 6, wherein the nanoporous carbon material is in a particulate form.

10. The system of claim 6, wherein the nanoporous carbon material is a monolith.

11. The system of claim 6, wherein the nanoporous carbon material includes one or more dopants.

12. The system of claim 11, wherein the one or more dopants are selected from the group consisting of gold, silver, zinc, magnesium, platinum, and aluminum.

13. The system of claim 12, wherein the one or more dopants comprise electrochemically active species.

14. The system of claim 6, wherein the nanoporous carbon material comprises a carbon aerogel.

15. The system of claim 14, wherein the carbon aerogel comprises a polyimide-derived carbon aerogel.

16. The system of claim 6,
wherein the pores form interconnected structures around the lithium metal, and
wherein the lithium metal and pore walls of each pore in which the lithium metal is surrounded are interconnected by a plurality of connection points.

17. The system of claim 6, wherein the nanoporous carbon material has a pore volume of at least 0.3 cc/g.

18. The system of claim 6, wherein the nanoporous carbon material has a porosity between about 10% and about 90%.

19. The system of claim 6, wherein the nanoporous carbon material has a capacity of between about 500 mAh/g and about 3000 mAh/g.

20. The system of claim 6, wherein the nanoporous carbon material has an electrical conductivity of at least about 1 S/cm.

21. The system of claim 6, wherein the pore structure comprises a pore size distribution full width at half max of about 50 nm or less.

22. The system of claim 6, wherein the pore structure comprises a pore size at max peak from distribution of about 100 nm or less.

23. The system of claim 6, wherein an average strut width of the fibrillar morphology of the nanoporous carbon material ranges from about 2 nm to about 10 nm.

24. The system of claim 6, wherein the system is an energy storage system.

25. The system of claim 24, wherein the energy storage system is a battery.

26. A method of controlling current at an interface in an energy storage system, the method comprising:
disposing lithium metal adjacent to a nanoporous carbon material.

27. The method of claim 26, wherein the nanoporous carbon material is a carbon aerogel.

28. The method of claim 26, wherein disposing lithium metal adjacent to a nanoporous carbon material comprises filling at least a portion of a void space in the nanoporous carbon material with the lithium metal.

29. The method of claim 26, wherein disposing lithium metal adjacent to a nanoporous carbon material comprises electrically connecting a layer of nanoporous carbon material to the lithium metal.

30-35. (canceled)

36. The system of claim 1, wherein the nanoporous carbon material comprises a carbon aerogel.

37. The system of claim 36, wherein the carbon aerogel comprises a polyimide-derived carbon aerogel.

38. The system of claim 1, wherein the nanoporous carbon material has a pore volume of at least 0.3 cc/g.

39. The system of claim 1, wherein the nanoporous carbon material has a porosity between about 10% and about 90%.

40. The system of claim 1 wherein the nanoporous carbon material has a capacity of between about 500 mAh/g and about 3000 mAh/g.

41. The system of claim 1, wherein the nanoporous carbon material has an electrical conductivity of at least about 1 S/cm.

42. The system of claim 1, wherein the pore structure comprises a pore size distribution full width at half max of about 50 nm or less.

43. The system of claim 1, wherein the pore structure comprises a pore size at max peak from distribution of about 100 nm or less.

44. The system of claim 1, wherein the system is an energy storage system.

45. The system of claim 44, wherein the energy storage system is a battery.
